(19) United States
(12) Patent Application Publication
(10) Pub. No.: US 2017/0132462 A1
(43) Pub. Date: May 11, 2017

(54) DOCUMENT CHECKING SUPPORT APPARATUS, DOCUMENT CHECKING SUPPORT SYSTEM, AND NON-TRANSITORY COMPUTER READABLE MEDIUM

(71) Applicant: FUJI XEROX CO., LTD., Tokyo (JP)

(72) Inventor: Kensuke KIYOZUKA, Kanagawa (JP)

(73) Assignee: FUJI XEROX CO., LTD., Tokyo (JP)

(21) Appl. No.: 15/076,982

(22) Filed: Mar. 22, 2016

(30) Foreign Application Priority Data
Nov. 10, 2015 (JP) 2015-220501

(51) Int. Cl. G06K 9/00

(52) U.S. Cl. CPC G06K 9/00449

(57) ABSTRACT

A document checking support apparatus includes a storage unit, a check item extracting unit, and a display unit. The storage unit stores check items each including a check region in a document and what to check in the document. The check item extracting unit extracts check items, each including a check region and what to check, for a check target document. The display unit displays the extracted check region and the extracted what to check along with the check target document.

### CROSS-REFERENCE TO RELATED APPLICATIONS

This application is based on and claims priority under 35 USC 119 from Japanese Patent Application No. 2015-220501 filed Nov. 10, 2015.

### BACKGROUND

(i) Technical Field

The present invention relates to a document checking support apparatus, a document checking support system, and a non-transitory computer readable medium.

(ii) Related Art

In a related art, a system that supports checking of information filled in a document has been proposed.

### SUMMARY

According to an aspect of the invention, a document checking support apparatus includes a storage unit, a check item extracting unit, and a display unit. The storage unit stores check items each including a check region in a document and what to check in the document. The check item extracting unit extracts check items, each including a check region and what to check, for a check target document. The display unit displays the extracted check region and the extracted what to check along with the check target document.

### BRIEF DESCRIPTION OF THE DRAWINGS

Exemplary embodiments of the present invention will be described in detail based on the following figures, wherein:

FIG. 1 is a system configuration diagram according to an exemplary embodiment;

FIG. 2 is a diagram illustrating an example of data stored in a check document DB;

FIG. 3 is a diagram illustrating an example of data stored in a check rule DB;

FIG. 4 is a diagram illustrating an example of data stored in a check item DB;

FIG. 5 is a flowchart (first) illustrating a process according to the exemplary embodiment;

FIG. 6 is a flowchart (second) illustrating a process according to the exemplary embodiment;

FIG. 7 is a diagram illustrating a screen example according to the exemplary embodiment;

FIG. 8 is a diagram illustrating another screen example according to the exemplary embodiment;

FIG. 9 is a diagram illustrating a screen example according to another exemplary embodiment; and

FIG. 10 is a diagram illustrating a screen example according to still another exemplary embodiment.

### DETAILED DESCRIPTION

Hereinafter, exemplary embodiments of the present invention will be described with reference to the drawings.

Principle

First, a fundamental principle of the present exemplary embodiment will be described.

In the present exemplary embodiment, check items for a check target document are stored in a database in advance. The check items each includes a check region in the check target document and what to check in the check target document. What to check is determined according to a type or the like of the check target document. For example, there are check items for a contract, check items for an application form, and check items for an approval document. The check region corresponds to, specifically, an entry column or a seal column, a signature column, a check column, and the like of the document. What to check is presence or absence of missing information, presence or absence of a seal, presence or absence of a signature, presence or absence of a number, presence or absence of date, presence or absence of authority, and the like.

If the check target document is computerized and is displayed on a terminal display as an image, and a region to be checked is highlighted with a guide, this is effective in the sense that the region to be checked may be easily visually recognized. However, in this case, it is cumbersome to recognize what to check. For example, even if a specific region of the document to be checked is emphasized and displayed with a guide, it is not clear what to check in the region, which requires a user to separately refer to a sample or the like. This is not efficient.

Therefore, in the present exemplary embodiment, check items corresponding to the type of the check target document are read from a database and are extracted, check regions included in the check items are displayed with guides along with the check target document, and what to check included in the check items are also displayed. The check regions and what to check are changed for each check item.

In other words, assuming that

a first check item
=(first check region, first what to check),

a second check item
=(second check region, second what to check), and

. . . ,

the first check region is different from the second check region, and thus first what to check and second what to check are generally changed (however, pieces of what to check may be the same as each other). Therefore, a position of a guide and what to check displayed along with the check target document in relation to the second check item are different from a position of a guide and what to check displayed along with the check target document in relation to the first check item. In other words, a position of a guide and what to check are dynamically changed due to a change of a check item. A user visually recognizes a guide and what to check displayed for each check item and may thus easily understand which portion is to be checked in the check target document and what item is to be checked.

On the other hand, in a case where the user has checked the check target document and has corrected the document as necessary with support through the displayed guide and the displayed what to check, it may be required to recheck the corrected document.

In this case, setting a check item for which O.K., that is, an affirmative result has been input by the user as a result of checking to be a recheck target is redundant and wasteful. Thus, the present exemplary embodiment excludes such a check item from recheck items. The present exemplary embodiment extracts other items as recheck items, displays check regions included in the recheck items with guides along with the corrected document, and displays what to check included in the recheck items. The above-described process is repeatedly performed a necessary number of times (for example, until check results of all check items are affirmative), and therefore it is possible to efficiently check a check target document and thus to easily ensure completeness of the document.

Configuration

Next, a specific configuration of the present exemplary embodiment will be described.

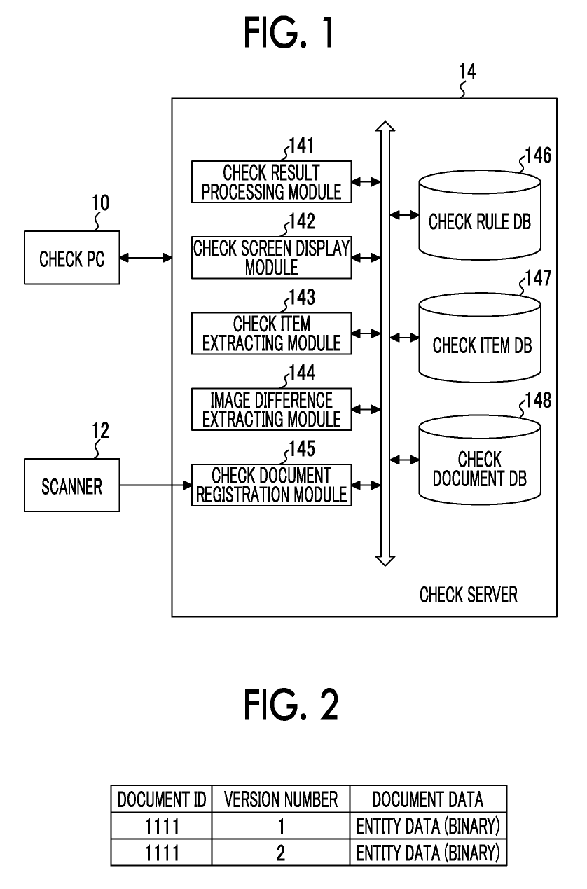

FIG. 1 is a functional block diagram illustrating a document checking support system in the present exemplary embodiment. The document checking support system includes a check personal computer (PC) 10 as a terminal, a scanner 12, and a check server 14. The check PC 10, the scanner 12, and the check server 14 are connected to each other via a communication line such as the Internet or a dedicated line.

The check PC 10 includes a CPU, a memory, an input device such as a keyboard, and an output device such as a display. A user operates the check PC so as to access the check server 14 and checks a document.

The scanner 12 electronizes a paper document through conversion into digital data, and outputs the digitalized document to the check server 14.

The check server 14 includes constituent elements as a server computer, that is, a CPU, a program memory, a working memory, a database, and an input/output interface. The check server 14 includes, as functional modules, a check result processing module 141, a check screen display module 142, a check item extracting module 143, an image difference extracting module 144, and a check document registration module 145. The check server 14 includes, as databases (DBs), a check rule DB 146, a check item DB 147, and a check document DB 148.

The check item extracting module 143 extracts a check item requiring rechecking from documents (which are electronized documents and may be recognized as images) of the check document DB 148, check rule items registered in the check rule DB 146, and check items registered in the check item DB 147.

The image difference extracting module 144 extracts a difference between document images of the check document DB 148.

The check screen display module 142 transmits and displays a check screen to and on the check PC 10. Specifically, a check target document image is displayed, and a guide surrounding a region of a check item is displayed thereon. A list of the check items is displayed in checking order, and a check result input by the user is displayed. In other words, the check screen display module 142 displays, on the display of the check PC, (1) the check target document image, (2) the guide surrounding the region of the check item, (3) the list of the check items, and (4) the check result.

The check result processing module 141 receives the check result transmitted from the check PC 10 and registers the check result in the check item DB 147.

The check document registration module 145 receives the check document transmitted from the scanner 12 and registers the check document in the check document DB 148. The check document registration module 145 registers the check document as a new version of a previously registered document in a case where the same document has been corrected. Determination of the same document is performed through a user's indication or by using an identifier such as QR Code (registered trademark).

The check rule DB 146 stores a check rule corresponding to each document. The check rule is constituted of position information and what to check of a corresponding document.

The check item DB 147 manages what to check of each document. The check item DB 147 stores a corresponding check rule, an identifier of a document, an affirmative or negative check result (OK/NG), and the like.

The check document DB 148 stores a check target document. In this case, a version of each document is also managed.

The respective modules 141 to 145 of the check server 14 are realized, specifically, by the CPU of the check server 14 executing a processing program stored in the program memory. In this sense, the respective modules 141 to 145 may be said to be software modules constituting the processing program executed by the CPU. Of course, the respective modules 141 to 145 may be realized by hardware modules.

Data Structure

FIG. 2 illustrates an example of data stored in the check document DB 148. A check target document is stored in correlation with a version number and document data for each document ID. In FIG. 2, the presence of version “1” and version “2” for the same document ID indicates that the document has been corrected once. The version “1” indicates an uncorrected original document, and the version “2” indicates a corrected document.

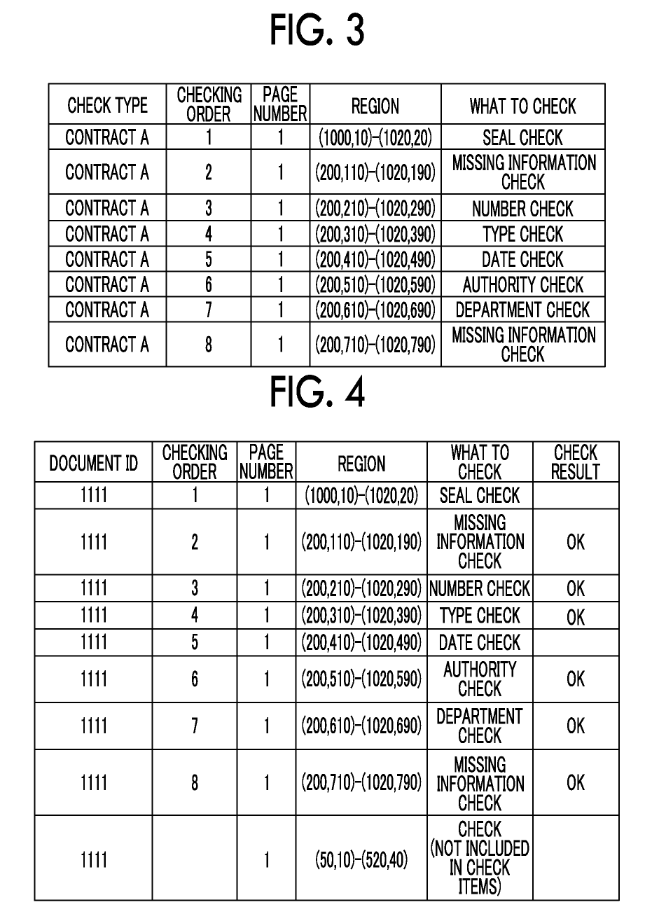

FIG. 3 illustrates an example of data stored in the check rule DB 146. The check type, a checking order, a page number, a region, and what to check are stored in correlation with each other. Here, the region is a check target region, and is represented in the form of (x0, y0)−(x1, y1) with an upper left point of a document as a reference point. FIG. 3 illustrates a check rule of a first page of a certain contract A. The region and what to check are stored for each checking order, and, for example, the checking order 1 is related to a rectangular region defined by (1000, 10)−(1020, 20) in the page, and what to check is to check the presence or absence of a seal. The checking order 2 is related to a rectangular region defined by (200, 110)−(1020, 190) in the page, and what to check is to check whether or not entry is omitted. A region may be changed for each document, and what to check maybe changed for each region and each document.

FIG. 4 illustrates an example of data stored in the check item DB 147. A checking order, a page number, a region, what to check, and a check result are stored in correlation with each other for each document ID. The check result is data which is input by the user via the check PC, and is either an affirmative result (“OK”) or a negative result (“NG”). For example, what to check for a region (200, 110)−(1020, 190) is to check whether or not entry is omitted, and the user inputs “OK” in a case where there is no missing information in the region. The input check result is transmitted from the check PC 10 to the check result processing module 141 of the check server 14, and is registered in the check item DB 147. The check result takes three values such as OK, NG, and null. An item whose value is null is required to be checked, and is an input waiting item from the user. An initial value of a check result is null. FIG. 4 illustrates that OK is input to what to check for the checking orders 2, 3, 4, 6, 7 and 8 as a result of the user performing checking, and the user does not confirm what to check for the remaining checking orders 1 and 5 yet, and check results are not input thereto. In addition, there is the item indicated by the region (50, 10)−(520, 40), but this will be described later.

Process

Next, a description will be made of a process during rechecking after the user checks and corrects an original document.

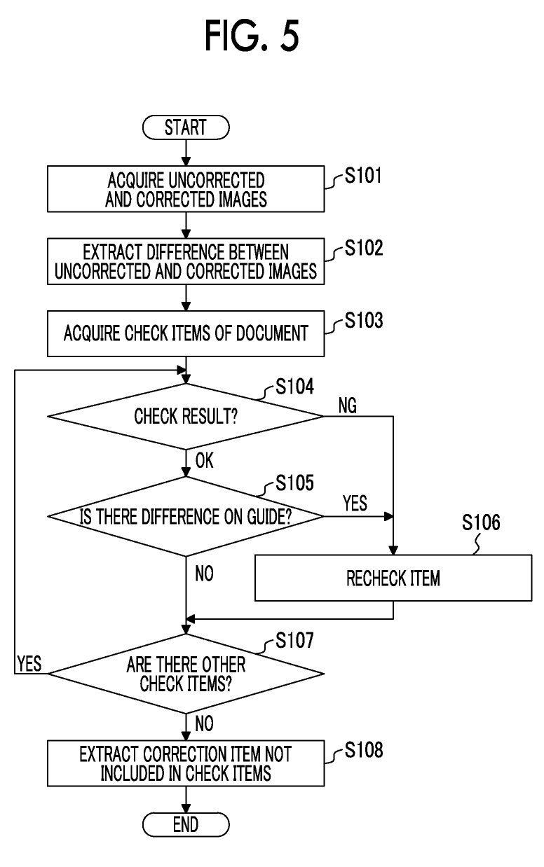

FIG. 5 is a flowchart illustrating a process according to the exemplary embodiment. First, the image difference extracting module 144 of the check server 14 reads uncorrected and corrected document images stored in the check document DB 148 (step S101). Specifically, a document image of a check target document in the latest version and a document image of the check target document in the previous version are read from the check document DB 148.

Next, the image difference extracting module 144 extracts a difference between the uncorrected and corrected document images (step S102). Consequently, a portion which has been corrected by the user is extracted as the difference.

Next, the check item extracting module 143 accesses the check item DB 147 and reads and acquires check items of the check target document (step S103). Regarding specific examples of the check items, FIG. 4 is referred to.

The check item extracting module 143 repeatedly performs the following processes for each check item after extracting the check items. In other words, first, it is determined whether a check result is OK or NG (step S104). It is assumed that a case where a value of a check item is null also included in a case where the check result is NG. If the check result is OK, then, it is determined whether or not the difference extracted in step S102 is present on a guide (step S105). If the check result is OK, and if there is no difference on the guide, this indicates that the user has not corrected the document, and thus this check item is excluded from recheck items. On the other hand, in a case where the check result is NG, or in a case where there is the difference on the guide even though the check result is OK, this indicates that the user has corrected the document, and thus the check item is set to be a recheck item (step S106). In order to set the check item to be a recheck item, specifically, a check result of the check item may be returned to null. The above-described processes are repeatedly performed until other check items do not remain (step S107).

The check item extracting module 143 extracts a portion corrected by the user and which fall in items not included in the check items (step S108).

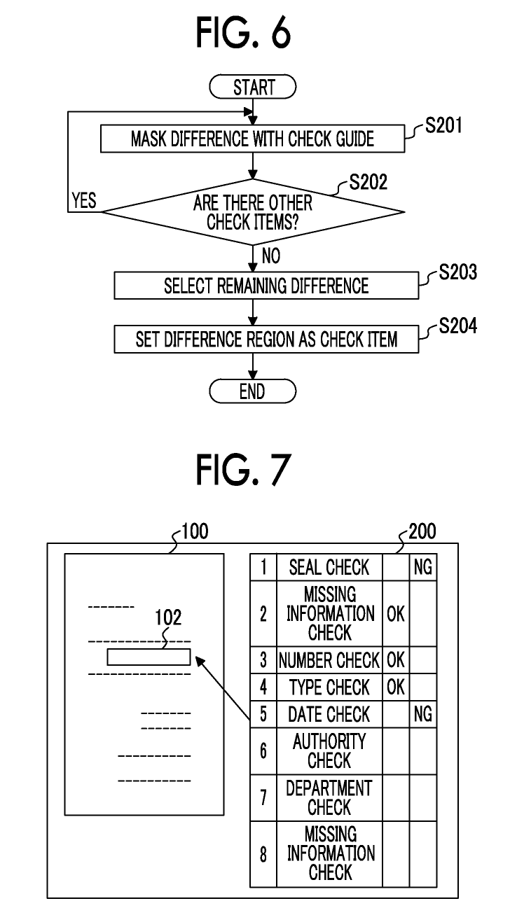

FIG. 6 is a flowchart illustrating the process in step S108 of FIG. 5, that is, the process of extracting a correction item not included in the check items.

First, the check item extracting module 143 repeatedly performs a process of masking the difference extracted in step S102 of FIG. 5 with a guide of a check item (check guide) for the respective check items (steps S201 and S202).

Next, if there is a difference which is not masked with the check guide, the difference is selected (step S203), and the selected difference region is registered in the check item DB 147 as a new check item (step S204).

Through the above process, in a case where the user has corrected a portion which is not included in check items, the corrected region is registered as a new check item and is set to be a recheck item. What to check of the corrected region is unknown, and thus only “check” is registered in the check item DB 147 as what to check.

Referring back to FIG. 4, data added at the lowermost end as data of the check item DB 147 indicates a correction item not included in the check items. “Check (not included in check items)” is newly registered as what to check along with position coordinates of the corrected region. A check result is null as an initial value. Therefore, during rechecking, the correction item not included in the check items is displayed on the display of the check PC 10 as a recheck item along with the recheck items set in step S106 of FIG. 5.

Screen Examples

FIG. 7 illustrates an example of a screen which is created by the check screen display module 142 and is displayed on the display of the check PC 10. The screen example corresponds to an example of a screen created during initial checking.

An image of a check target document 100 is displayed on the left part in the screen, and a check item list 200 which lists check items read from the check rule DB 146 is displayed on the right part in the screen. The check item list 200 sequentially lists the check items from the bottom according to a checking order. Buttons for “OK” and “NG” are displayed on the right side of each check item, and the user may input a check result by selecting either one thereof. A region of each check item is displayed with a guide 102 in the image of the document 100. In FIG. 7, as an example, a region of a check item of “date check” for the checking order “5” is illustrated.

The user focuses on the specific region of the document 100 which is highlighted with the guide 102, and focuses on the check item list 200 so as to check the region according to what to check. For example, in FIG. 7, the user focuses on the specific region which is highlighted with the guide 102, focuses on “date check” of the check item list 200, and checks whether or not the date written in the specific region which is highlighted with the guide 102 is the accurate date. If the date is the accurate date, the “OK” button is selected and is input as a check result of the check item of “date check”, and if the data is not the accurate date, the “NG” button is selected and is input as a check result. FIG. 7 illustrates a situation in which the user inputs NG for “1 seal check”, OK for “2 missing information check”, OK for “3 number check”, OK for “4 type check”, and NG for “5 date check” in the above-described manner. The user fundamentally checks all check items according to the guide 102, inputs check results by operating the OK button or the NG button, and transmits the check results to the check server 14.

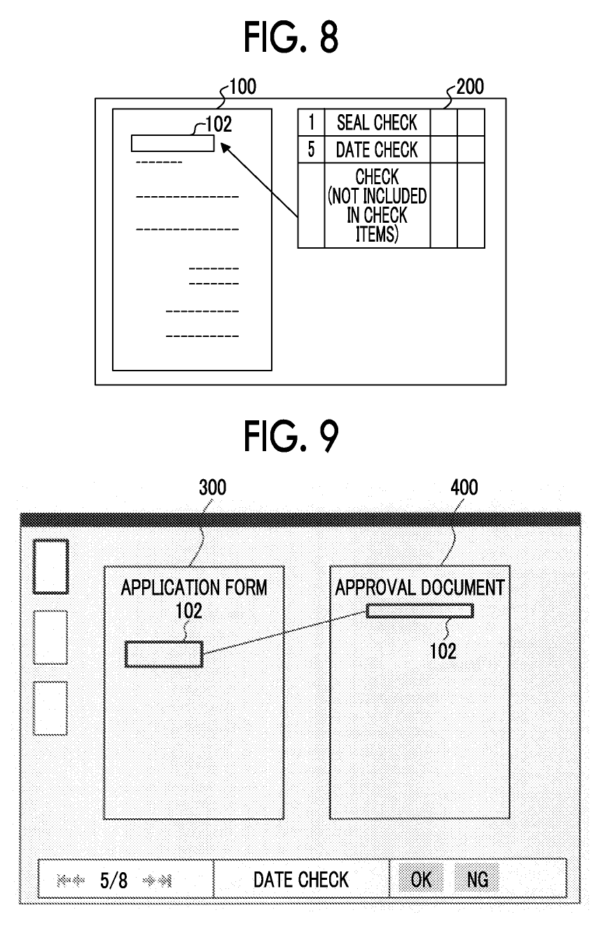

FIG. 8 illustrates a screen example during recheck. The check server 14 performs the processes illustrated in the flowcharts of FIGS. 5 and 6 so as to set a recheck item and also extract correction to which any correction item is not applicable.

An image (corrected image) of a check target document 100 is displayed on the left part in the screen, and a check item list 200 which lists check items read from the check rule DB 146 is displayed on the right part in the screen. In the check item list 200 illustrated in FIG. 8, compared with the check item list 200 illustrated in FIG. 7, the items for which OK is input as check results are excluded, and a correction item not included in the check items is listed. In FIG. 8, the region not included in the check items is highlighted with a guide 102. The user checks the corrected document again according to the guide 102 and the check item list 200, and inputs OK or NG for each check item.

Hereinafter, a process according to the present exemplary embodiment will be described in more detail.

It is assumed that the user creates a certain document, for example, an application form, accurately fills in a specific region A, and forgets putting a seal in a specific region B.

The user creates the document, and electronizes the document with the scanner 12 so as to transmit the document to the check server 14. The check server 14 extracts check items corresponding to the application form as the type of document, and displays the check items along with an image of the document on the check PC 10. The check items include what to check of “missing information check” for the specific region A, and what to check of “seal check” for the specific region B.

Since a guide 102 of the specific region A and what to check of “missing information check” are displayed along with the image of the document on the display of the check PC 10, if the user visually recognizes the image of the document and confirms that there is no missing information in the specific region A, the user inputs OK as a check result of the check item by operating the OK button. If the user confirms that there is no seal in the specific region B, the user inputs NG as a check result by operating the NG button. The input check results are transmitted from the check PC 10 to the check server 14 and are registered in the check item DB 147.

Since the user may confirm that a seal is omitted in the specific region B based on the check result, the user corrects the document by putting a seal in the specific region B of the document, electronizes the corrected document with the scanner 12 again, and transmits the document to the check server 14. The uncorrected document and the corrected document are registered in the check document DB 148 of the check server 14 as documents in different versions. The check server 14 extracts a difference between both the documents, and thus the presence or absence of the seal is extracted as the difference. Since a region extracted as the difference corresponds to a check item, the check server 14 displays the guide 102 in the specific region B again so as to display what to check of “seal check”. If the user visually recognizes the image of the document and confirms that the seal is present in the specific region B, the user inputs OK as a check result of the check item by operating the OK button.

As mentioned above, in the present exemplary embodiment, an image of a check target document is displayed on a screen, a location to be checked is highlighted with the guide 102, and the check item list 200 is also displayed so that what to check is displayed. Therefore, the user is not required to confirm what to check separately, and may very easily check an entry location of the document.

FIG. 9 illustrates another example of a screen which is created by the check screen display module 142 and is displayed on the display of the check PC 10. The screen example corresponds to an example of a screen created during initial checking.

In this example, a first document 300 as a check target document and a second document 400 corresponding thereto are displayed so as to be compared with each other on the screen of the check PC 10. The first document 300 is, for example, an application form or a contract, and the second document 400 is, for example, an approval document corresponding to the application form or the contract. FIG. 9 illustrates an application form as the first document 300 and an approval document as the second document 400.

An image of the first document 300 is displayed on the left part in the screen, and an image of the second document 400 is displayed on the right part in the screen. A check item list 200 which lists check items read from the check rule DB 146 is displayed by one row on the lower part in the screen. In FIG. 9, among a total of eight check items, the check item of “date check” which is the fifth item is displayed. A region corresponding to the check item is displayed with a guide 102. The guide 102 highlights the region in the image of the first document 300 and the corresponding region in the image of the second document 400, and, preferably, mutual correspondence is indicated by connecting the guide 102 in the first document 300 to the guide 102 in the second document 400 via a line as illustrated in FIG. 9.

The check item list 200 displayed by one row is automatically moved to the next check item through an operation of an OK or NG button, and the next check item is displayed. In other words, in FIG. 9, if the user operates the OK button, the check item list 200 is moved to the sixth check item, and the check item of “authority check” which is the sixth check item is displayed. Along therewith, a new guide 102 corresponding to the authority check is also displayed.

If a predetermined period of time elapses, a check item may be automatically moved, and, in this case, OK or NG may be selected by default. The check items may be freely moved by using forward and backward buttons.

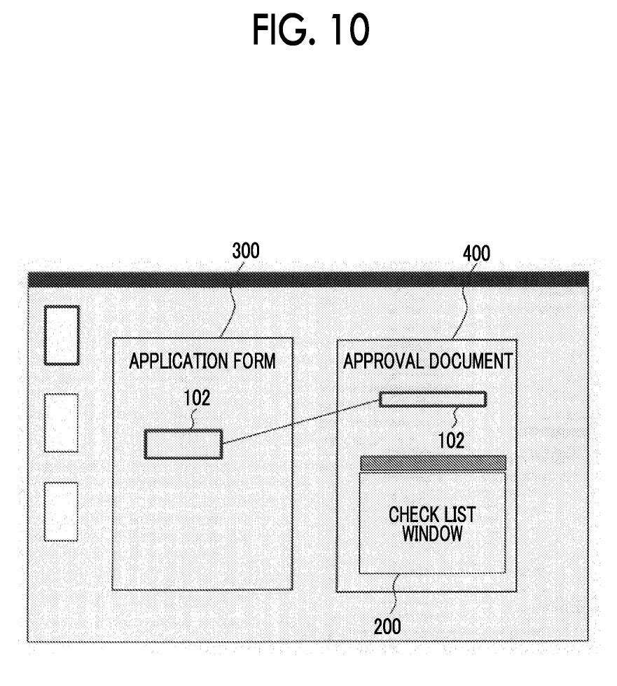

FIG. 10 illustrates still another example of a screen which is created by the check screen display module 142 and is displayed on the display of the check PC 10. The screen example corresponds to an example of a screen created during initial checking.

Also in this example, a first document 300 as a check target document and a second document 400 corresponding thereto are displayed so as to be compared with each other on the screen of the check PC 10.

An image of the first document 300 is displayed on the left part in the screen, and an image of the second document 400 is displayed on the right part in the screen. A check item list 200 which lists check items read from the check rule DB 146 is displayed as a check list window, but is displayed at a position which does not overlap a guide 102. This indicates that a display position of the check item list 200 may be adaptively changed according to a position of the guide 102 which may be changed according to a check item. Also in this example, the user may easily understand what to check while checking the guide 102.

In the examples illustrated in FIGS. 7, 8 and 9, the check item list 200 is displayed so as not to overlap the check target document, but, in the example illustrated in FIG. 10, it is noted that the check item list 200 overlaps the check target document but is displayed so as not to overlap the guide 102.

As mentioned above, the exemplary embodiment of the present invention has been described, but the present invention is not limited thereto and may be variously modified.

For example, in the present exemplary embodiment, as illustrated in FIG. 1, there is a system configuration in which the check PC 10 is connected to the check server 14 via the network, but the check PC 10 side may have the functions of the respective modules 141 to 145 and the databases 146 to 148 of the check server 14, and thus the check PC 10 may function as a document checking support apparatus. The check PC 10 side may have some of the functions of the respective modules 141 to 145 and the databases 146 to 148 of the check server 14.

In the present exemplary embodiment, a thick frame surrounding a region is used as the guide 102, but any form for highlighting a specific region more than other regions may be used.

Instead of the check PC 10, a tablet terminal or a smart phone including a CPU, a memory, and a touch panel maybe used.

In the present exemplary embodiment, the guide 102 and what to check for a check item are displayed in relation to the check target document 100, but, if a document which is different from the original check target document 100 is wrongly displayed, deviation or mismatch occurs between a region of the display document, and the guide 102 and what to check. Therefore, there may be a configuration in which it is detected that the wrong document is an inspection target by using the presence of the mismatch, and, for example, a warning is displayed on the check PC 10. In other words, the guide 102 and what to check of the present exemplary embodiment may be used as an index for determining the validity of the check target document.

In the present exemplary embodiment, the guide 102 and the check item list 200 are displayed along with the check target document 100, but what to check may be displayed in a pop-up form when a cursor or a pointer is located at the guide 102. When what to check is displayed, what to check may be output by voice.

If plural items of what to check are set for the same region in relation to the regions and hat to check stored in the check rule DB 146, there may be a configuration in which check items are updated to be reduced by integrating the plural items of what to check through a user's operation on the check PC 10.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A document checking support apparatus comprising:
a storage unit that stores check items each including a check region in a document and what to check in the document;
a check item extracting unit that extracts check items, each including a check region and what to check, for a check target document; and
a display unit that displays the extracted check region and the extracted what to check along with the check target document.

2. The document checking support apparatus according to claim 1, further comprising:
an input unit that receives a check result for each displayed what to check,
wherein the storage unit stores the input check result, and
wherein during rechecking, the check item extracting unit extracts check items with excluding a check item whose check result is affirmative.

3. The document checking support apparatus according to claim 1, further comprising:
a difference extracting unit that extracts a difference between an uncorrected check target document and a corrected check target document,
wherein in a case where the extracted difference does not match any of the check regions extracted by the check item extracting unit, the storage unit additionally stores the extracted difference as a new check item.

4. The document checking support apparatus according to claim 2, further comprising:
a difference extracting unit that extracts a difference between an uncorrected check target document and a corrected check target document,
wherein in a case where the extracted difference does not match any of the check regions extracted by the check item extracting unit, the storage unit additionally stores the extracted difference as a new check item.

5. The document checking support apparatus according to claim 1,
wherein the extracted check regions and the extracted what to check are displayed on the display unit so that the extracted check regions and the extracted what to check do not overlap the check target document.

6. The document checking support apparatus according to claim 2,
wherein the extracted check regions and the extracted what to check are displayed on the display unit so that the extracted check regions and the extracted what to check do not overlap the check target document.

7. The document checking support apparatus according to claim 3,
wherein the extracted check regions and the extracted what to check are displayed on the display unit so that the extracted check regions and the extracted what to check do not overlap the check target document.

8. The document checking support apparatus according to claim 4,
wherein the extracted check regions and the extracted what to check are displayed on the display unit so that the extracted check regions and the extracted what to check do not overlap the check target document.

9. The document checking support apparatus according to claim 1,
wherein the extracted check regions and the extracted what to check are displayed on the display unit so that the extracted check regions and the extracted what to check do not overlap a check region in the check target document.

10. The document checking support apparatus according to claim 2,
wherein the extracted check regions and the extracted what to check are displayed on the display unit so that the extracted check regions and the extracted what to check do not overlap a check region in the check target document.

11. The document checking support apparatus according to claim 3,
wherein the extracted check regions and the extracted what to check are displayed on the display unit so that the extracted check regions and the extracted what to check do not overlap a check region in the check target document.

12. The document checking support apparatus according to claim 4,
wherein the extracted check regions and the extracted what to check are displayed on the display unit so that the extracted check regions and the extracted what to check do not overlap a check region in the check target document.

13. The document checking support apparatus according to claim 1,
wherein the check target document includes a first document and a second document corresponding to the first document, and
wherein the first document and the second document are displayed on the display unit so as to be compared with each other.

14. The document checking support apparatus according to claim 2,
wherein the check target document includes a first document and a second document corresponding to the first document, and
wherein the first document and the second document are displayed on the display unit so as to be compared with each other.

15. The document checking support apparatus according to claim 3,
wherein the check target document includes a first document and a second document corresponding to the first document, and
wherein the first document and the second document are displayed on the display unit so as to be compared with each other.

16. The document checking support apparatus according to claim 4,
wherein the check target document includes a first document and a second document corresponding to the first document, and
wherein the first document and the second document are displayed on the display unit so as to be compared with each other.

17. The document checking support apparatus according to claim 5,
wherein the check target document includes a first document and a second document corresponding to the first document, and
wherein the first document and the second document are displayed on the display unit so as to be compared with each other.

18. The document checking support apparatus according to claim 6,
wherein the check target document includes a first document and a second document corresponding to the first document, and
wherein the first document and the second document are displayed on the display unit so as to be compared with each other.

19. A document checking support system comprising:
a terminal; and
a server,
wherein the server includes
a storage unit that stores check items each including a check region in a document and what to check of a document, and
a check item extracting unit that extracts check items, each including a check region and what to check, for a check target document from the storage unit, and
wherein the terminal includes
a display unit that displays the extracted check region and the extracted what to check along with the check target document, and
an input unit that receives a check result.

20. A non-transitory computer readable medium storing a program causing a computer to execute a process for document checking support, the process comprising:
storing check items each including a check region in a document and what to check in the document, in a storage unit;
extracting check items, each including a check region and what to check, for a check target document from the storage unit; and
displaying the extracted check region and the extracted what to check along with the check target document on a display unit.
